(19) United States
(12) Patent Application Publication
(10) Pub. No.: US 2009/0038964 A1
(43) Pub. Date: Feb. 12, 2009

(54) Chewing gum pocket

(76) Inventor: Joy B. Jacobs, Gatesville, TX (US)

Correspondence Address: JAMES RAY & ASSOCIATES, 2640 PITCAIRN ROAD, MONROEVILLE, PA, 15146, US

(21) Appl. No.: 11/890,757

(22) Filed: Aug. 7, 2007

(51) Int. Cl. B65D 71/00; B65D 73/00; B65D 79/00; B65G 59/00

(52) U.S. Cl. 206/233; 206/494; 206/527; 221/92

(57) ABSTRACT

A chewing gum pocket having a flexible sheet with a smooth surface with a first surface, an obverse second surface, a longitudinal axis and a transverse axis. Tacky adhesive is applied as transverse bands at opposing ends of said first side of said sheet. Said sheet is scored along a generally transverse axis, generally bisecting said sheet. The sheet can then be folded so as to form a pocket with a smooth surface for temporarily store previously chewed gum for continued use or a tacky interior surface for disposal of said chewing gum. Said pocket is manufactured in a sterile environment. Releaseable sheets cover said first and second sides of said sheet and are enclosed in an envelope for convenient distribution.

### CROSS REFERENCE TO RELATED APPLICATION

This patent application is related to U.S. Provisional Patent Application Ser. No. 60/793,365, filed Apr. 20, 2006.

### FIELD OF THE INVENTION

The present invention relates, in general, to chewing gum storage and disposal and, more particularly, this invention relates to a reversible pocket for the temporary storage of chewing gum and its disposal.

### BACKGROUND OF THE INVENTION

Prior to the conception and development of the present invention, as is generally well known in the prior art, there are folding pockets for the disposal of chewing gum. A pocket for the reuse of chewing gum requires a sterile pocket. However, prior devices were for the disposal of chewing gum and could not form a sterile pocket or be used to store previously chewed gum for later continued use of the chewing gum or and be used for disposal.

### SUMMARY OF THE INVENTION

The present invention provides a longitudinal sheet with a first side, obverse second side. The flexible sheet has a longitudinal axis and a transverse axis. A tacky adhesive is applied in generally transverse bands across the opposing ends of the flexible sheet and the complete second surface. A generally transverse score generally bisect the flexible sheet. The user can elect to fold the flexible sheet along the score to form a temporary pocket for the storage of chewing gum for continued use or a permanent pocket for disposal or chewing gum.

A release sheet at least of the same dimensions of the flexible sheet is attached to each of the first and second sides of the flexible sheet so as to cover the applied adhesive, so that the sheet can be handled without sticking to other surfaces.

The assembled flexible sheets and release sheets are enclosed in an envelope. The envelope and assembled pocket permits the pocket to be produced and delivered to the user in a sterile condition. The user removes the assembled flexible sheet and release sheets from the envelope. The release sheets are removed and the flexible sheet is folded into a temporary pocket for reuse of chewing gum or for its permanent disposal.

### OBJECTS OF THE INVENTION

It is, therefore, one of the primary objects of the present invention to provide a pocket that can be used to temporarily store previously chewed gum or electively to permanently store chewing gum for disposal.

Another object of the present invention is to provide a pocket for the storage and disposal of previously chewed gum in a sterile package.

Still another object of the present invention is to provide a pocket with a simpler design for manufacture.

Yet another object of the present invention is to provide a convenient assembly of a pocket which permits the user to handle the pocket without touching the pocket surface.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a plan view of first side of the flexible sheet.

FIG. 2 is a plan view of the obverse second side of the flexible sheet.

FIG. 3 is a perspective view of the pocket being disabled.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

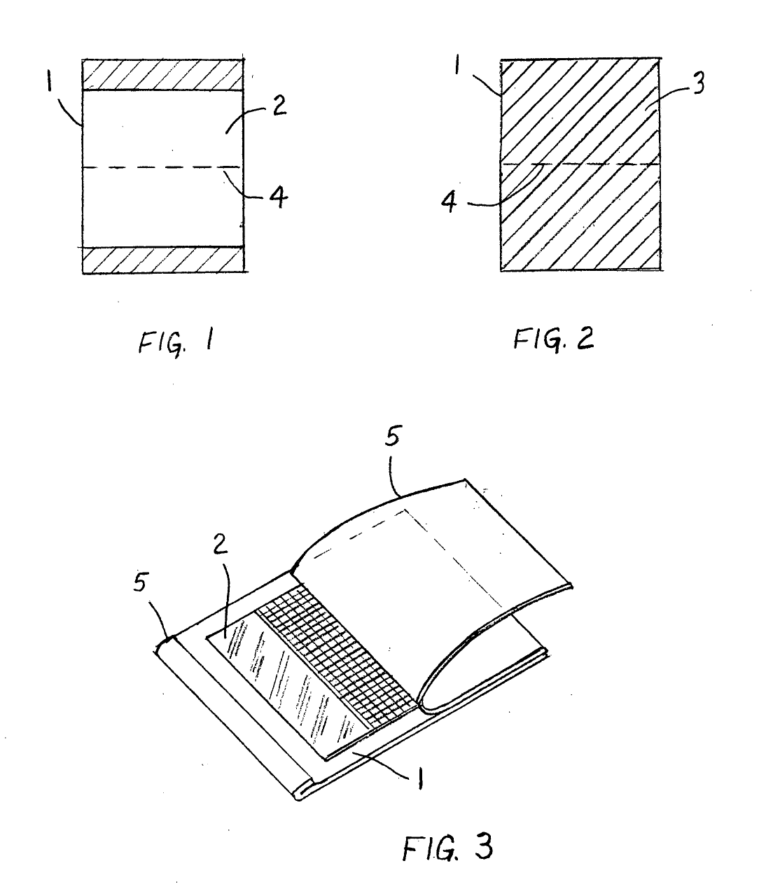

Reference is now made, more particularly, to FIGS. 1 and 2 where depicting a flexible sheet 1 with a first side 2 and an obverse second side 3 having with a longitudinal and transverse axis. Sheet 1 has a smooth surface and preferably manufactured of plastic or paper.

A tacky adhesive is applied to the first side 2 of sheet 1 in generally transverse bands 3 at opposing ends of sheet 1. Adhesive is also applied to substantially all of second side 3 of sheet 1. The adhesive in the preferred embodiment is of the type used for pressure sensitive self-stick note pads.

Sheet 1 has a score 4 along a generally transverse axis generally bisecting sheet 1. The score 4 permits the user to fold the pocket so that the pocket has an interior smooth surface or an interior tacky adhesive surface.

Release sheets 5 are of a predetermined width and length greater than the dimensions of sheet 1. The release sheets are attached by said tacky adhesive to sides 2 and 3 of sheet 1. By covering sheet 1, the release sheets 5 permit said sheet 1 to be handled with contacting the surface of sheet 1. The sheets in the preferred embodiment are manufactured in a sterile environment so that chewing gum does not come into contact with a non-sterile surface when the pocket is used to temporarily store such chewing gum. Said release sheets 5 are preferably manufactured from a group of plastic or paper.

In the preferred embodiment said sheet 1 and release sheets 5 are assembled and the assembly is covered with an envelope (not shown). Said envelope allows the packaged pocket to be conveniently distributed packet and remain sterile. In the preferred embodiment, said envelope is manufactured of paper.

The packet can be distributed at restaurants, groceries, convenience store, public entertainments and the like. The packets can be contained in a conventional packet dispenser. In the preferred embodiment, a kit of a combination of refillable dispenser and packets is used.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A pocket for chewing gum:
a sheet of a predetermined material with a predetermined length width and depth with a longitudinal axis and a transverse axis having a first side and an obverse second side;
an adhesive applied in band of predetermined width along the transverse axis at opposing ends of said longitudinal axis of said sheet;
an adhesive applied to coat a predetermined portion of said obverse second side of said sheet;
a scored portion of said sheet along the transverse axis generally bisecting said sheet so that said sheet can be folded along said scored portion to form a pocket wherein said opposing end of said first side form a pocket for temporary storage of such chewing gum or said second surface when folded form a pocket for the disposal of such chewing gum.
a first releasable sheet of predetermined material affixed to said first side of said sheet;
a second releasable sheet of predetermined material affixed to said second side of said sheet; and

2. A pocket according to claim 1 wherein sheet of predetermined material is one of a group of plastic and paper.

3. A pocket according to claim 1 wherein said predetermined portion of said second obverse side of said sheet is substantially all of said second obverse side of said sheet.

4. A pocket according to claim 1 wherein said predetermined material of said first and second releasing sheets is one of the group paper and plastic.

5. A pocket according to claim 1 further including an envelope of predetermined length and width enclosing said sheet and said release sheets and sealed by a sealing means.

6. A pocket according to claim 5 in which said envelope sealing means is of a group of adhesive and crimping.

7. A pocket according to claim 1 wherein said sheet and said release sheets are manufactured and assembled in a sterile environment.

8. A pocket for chewing gum:
a sheet of a predetermined material with a predetermined length width and depth with a longitudinal axis and a transverse axis having a first side and an obverse second side;
an adhesive applied in strip of predetermined width along the transverse axis at opposing ends of said longitudinal axis of said sheet;
an adhesive applied to coat a predetermined portion of said obverse second side of said sheet;
a scored portion of said sheet along the transverse axis generally bisecting said sheet so that said sheet can be folded to form a reusable pocket wherein said opposing end of said first side form a pocket for temporary storage of such chewing gum or said second surface when folded form a pocket for the disposal of such chewing gum.
a first releasable sheet of predetermined material affixed to said first side of said sheet;
a second releasable sheet of predetermined material affixed to said second side of said sheet; and
an envelope of predetermined material enclosing said sheet and said first and second releasable sheets, said envelop sealed with a sealing means.

9. A pocket according to claim 8 wherein sheet of predetermined material is one of a group of plastic and paper.

10. A pocket according to claim 8 wherein said predetermined portion of said second obverse side of said sheet is substantially all of said second obverse side of said sheet.

11. A pocket according to claim 8 wherein said predetermined material of said first and second releasing sheets is one of the group paper and plastic.

12. A pocket according to claim 8 in which said envelope sealing means is of a group of adhesive and crimping.

13. A pocket according to claim 8 wherein said sheet and said release sheets are manufactured and assembled in a sterile environment.

14. A dispenser kit for dispensing chewing gum pockets comprising:
a plurality of chewing gum pockets for chewing gum comprising a sheet of a predetermined material with a predetermined length width and depth with a longitudinal axis and a transverse axis having a first side and an obverse second side; an adhesive applied in strip of predetermined width along the transverse axis at opposing ends of said longitudinal axis of said sheet; an adhesive applied to coat a predetermined portion of said obverse second side of said sheet; a scored portion of said sheet along the transverse axis generally bisecting said sheet so that said sheet can be folded to form a reusable pocket wherein said opposing end of said first side form a pocket for temporary storage of such chewing gum or said second surface when folded form a pocket for the disposal of such chewing gum. a first releasable sheet of predetermined material affixed to said first side of said sheet; and an envelope of predetermined material enclosing said sheet and said first and second releasable sheets, said envelope sealed with a sealing means.
a dispenser with a case, interior top portion and interior bottom portion, compressible spring with a bottom end in contact with said bottom interior portion of said dispenser, a compression member with a top and bottom portion, said bottom portion of said compression member in contact with said top portion of said compressible spring, said chewing gum pockets received between said top portion of said compression member and said top interior portion of said dispenser, and a cover member releaseably attached to said front of said dispenser, providing access to said interior of said dispenser to refill said pockets.
